(19) United States
(12) Patent Application Publication
(10) Pub. No.: US 2009/0222908 A1
(43) Pub. Date: Sep. 3, 2009

(54) Device for Transmission of Stored Password Information Through a Standard Computer Input Interface

(76) Inventor: Russell Warren, Ottawa (CA)

Correspondence Address: FLYNN THIEL BOUTELL & TANIS, P.C., 2026 RAMBLING ROAD, KALAMAZOO, MI, 49008-1631, US

(21) Appl. No.: 11/921,420

(22) PCT Filed: Jun. 1, 2006
(86) PCT No.: PCT/CA2006/000892

§ 371 Date: Apr. 13, 2009

Related U.S. Application Data
(60) Provisional application No. 60/595,044, filed on Jun. 1, 2005.

(51) Int. Cl. H04L 9/32; G06F 3/00; G06F 12/14

(52) U.S. Cl. 726/18; 710/1

(57) ABSTRACT

A novel password management device is interposed between a computer and a conventional computer input device such as a keyboard. Passwords are defined at the input device, stored in a preferably encrypted password vault and forwarded to a secure application. When the user is prompted for a password, the device retrieves the password from the vault and provides it to the computer in a manner indistinguishable from conventional data traffic, mitigating the likelihood that the innocuous data stream will be monitored to recover the password. The transmission of a password is push technology and may be enhanced by a gating feature. Automatic password retrieval from the vault is convenient to the user, particularly if the device automatically generates random passwords. No software is installed on the computer; the device is operating system, application and platform independent. The device may be integrated within the input device or within the computer itself.

### RELATED APPLICATIONS

This Application claims priority from U.S. Provisional Application No. 60/595,044 filed Jun. 1, 2005.

### FIELD OF THE INVENTION

The present invention relates to password management systems and in particular to a novel password management device that enables innocuous storage and transmission upon user input of passwords to a computer using a standard input interface in a manner indistinguishable to the computer operating system.

### BACKGROUND TO THE INVENTION

Today's modern preoccupation with computer security has created a serious problem for computer users, namely the proliferation of password systems and passwords. For the purposes of the present invention, password is defined as including any piece of secure data, such as, but not limited to a computer password, a login identity, a credit card number, a document or even a picture, biometric or other data, that must be provided in digital form in order to gain access to a computer program and/or an electronic database or service, which are generally denoted as a security application.

There are numerous password systems and numerous corresponding passwords maintained by a computer user. Consequently, there is a plurality of password management systems (PMS) known in the art in order to assist the user in managing the problem of password proliferation without having to keep track of a large variety of different passwords.

In general, such password management systems can be categorized as falling within one of two types. In the first type, common passwords are used for more than one application so that the total number of required passwords to be maintained is reduced to a more manageable number, ideally just one.

Unfortunately, conventional systems falling within this type of system suffer from several disadvantages. First, it is highly unlikely that the developers of all of the security applications that require a user's personal authentication will all agree on a single universal standard. Second, even if such a universal approach were accepted, whether a single password or a single password system, the very acceptance of such an approach would raise significant security issues. As a simple example, were all security applications to be accessible by a single password, a person gaining access to such password would by definition be able to gain access to all of the user's security applications. Since each security application will require the disclosure of the password to at least one entity (such as a database or a systems administrator), the possibility will always exist that an unscrupulous individual will gain unauthorized access to the user's security applications.

Other embodiments of the single sign-on approach include the use of biometrics, smartcards and or other physical tokens intended to identify a single user. These embodiments make use of one or a combination of three aspects of a user's identity, namely what the user is, what the user has and what the user knows.

Despite the significant security issues raised by single sign-on approaches, such approaches may be feasible in a captive enterprise environment where a system administrator can set up a single authentication server or application, which can be configured to grant access to each of a company's enterprise security applications. In such a controlled environment, a password reduction approach may be suitable. Nevertheless, a user in such an environment will wish to access security applications outside of the controlled environment. In such a case, there will still be a need for multiple passwords to access these security applications. Inherently, the system administrator would prefer that the single authentication password used for the company's security applications be different from those used to access outside security applications in order to maximize the security of the company's environment. For example, users may wish to access work-related forums, online journals or blogs, and attend to personal matters such as online banking and shopping applications.

The second type of password management system is to use a password management tool. Again, many options are commercially available. For convenience, these options may be categorized as software or hardware solutions.

The premise behind most software solutions is to maintain a vault or file of passwords available somewhere on the computer and to keep such a vault secure from prying eyes with an advanced encryption algorithm. When a user wishes to obtain access to a password from within the vault, the installed software of the system will obtain from the user the information required to decrypt the password, in the form of a second password and decrypt and extract the secure data. Typically, the installed software will also automatically provide data fill capability in the security application being accessed, provided that the application supports such capability. If such capability is not provided, the user will manually switch between the password management application to extract the password data and then copy or transcribe it across to the security application that requires it for access.

Typically, most software-only solutions suffer from a number of disadvantages. First, the password vault is typically installed on the computer, in order to make use of the computer's processing power to decrypt and otherwise manage the vault. Unfortunately, this renders the vault vulnerable to attack since no encryption system is perfect. There are numerous methods known in the art, including but not limited to dictionary attacks or other brute force methods for gaining access to the vault. Indeed, the very computer processing power used to decrypt the vault may be applied to attacking the encryption of the software system.

Second, because the software system is installed on a particular computer, it is manifest that the vault will only be able to conveniently manage passwords for security applications resident or accessible from that computer. Even with a “portable” PMD, some sort of software process, application or library must be installed on the computer in order to access the vault and the passwords stored therein. With the growing prevalence of computers in modern society, including wireless cell phones and personal digital assistants, it is unusual to find a user that access all security applications through a single computer.

Third, such software systems will be dependent upon the operating system governing the particular computer. Those having ordinary skill in this art will readily recognize that it is non-trivial to develop a single application that is capable of running on a multiplicity of operating systems including wireless and PDA systems. Moreover, some more prevalent computer operating systems are correspondingly more vulnerable to security attack.

The premise behind hardware-based password management systems is that the password vault is physically separated from the computer accessing the security application. This is sometimes referred to in the art as providing an “air-gapped” solution. Such solutions overcome many of the inherent disadvantages of software password management systems. A decidedly low-tech but surprisingly near universal hardware approach is to write down one's passwords on a sheet of paper that is stored somewhere, such as a desk drawer, or incredibly, in some case, taped to the computer monitor itself!

However, hardware-based systems also suffer from disadvantages in that those hardware systems known in the art either require the user to physically transcribe the password from the vault to the security application or else require software to be installed to enable the transfer of the password to the computer.

In the former case, much of the advantage, in terms of ease of use, of a password management system is lost. If convenience features are introduced, these tend to threaten the security advantages of hardware systems. For example, if the hardware system comprises a sheet of paper, the security may be maintained by storing the sheet in a safe. However, if, in the name of convenience, the safe is left unlocked, or the sheet left out in plain view, the security advantages are largely foregone.

Similarly, if in the name of convenience, the sheet of paper is replaced by storage in an electronic device such as a cellular phone or PDA, security may be compromised when the device is synchronized with the computer as such a data stream would be targeted by a hacker knowing of the presence of the vault on the handheld device. Because such data streams are relatively discrete and isolated, they are easily targeted.

In the latter situation, that is, where software is installed, many of the disadvantages of software management systems are reintroduced into the hardware system. Additionally, the installed software may not be compatible with all of the security applications for which password data is to be maintained in the hardware vault. Still further, the presence of the installed software may serve as a flag to a hacker to monitor activity namely password information passing across a custom interface between the installed software and the security application.

Accordingly, it is desirable to provide an innovative password management system that provides the security features of a hardware system with the convenience provided by software systems.

### SUMMARY OF THE INVENTION

The present invention accomplishes these aims by providing a hardware isolated password management device (PMD) that is capable of connection to a computer in an innocuous fashion that is relatively indistinguishable from conventional data traffic.

The novel PMD of the present invention is connected to a conventional keyboard connection of the computer in such a fashion that the data flow between the data vault on the PMD and the computer is not easily targeted.

Advantageously, the inventive PMD requires no software to be installed on the computer and can be used with any computer device that permits serial transmission of keystroke data across its keyboard connection. As such, it is operating system and security application independent.

Conveniently, the connection of the PMD of the present invention in such a fashion permits convenient automatic storage of the password in the vault by the process of keying in the password into the security application itself. Alternatively, the password could be automatically generated by the vault for storage therein and optionally forwarded to the security application along the keyboard connection.

Beside being hidden within innocuous data flows along the keyboard connection, the inventive PMD preferably inhibits attack on its vault from the computer by maintaining a user-enabled connection between the PMD vault and the computer. The computer is unable to read password data from the PMD vault. Thus, the transmission of password data between the vault and the computer is a “push” technology and thus less vulnerable to unauthorized access. For additional security, the data flow from the computer to the PMD may also be gated

Preferably, the password data may be maintained in encrypted form within the PMD vault. While the security afforded to the user by the inventive PMD is maintained dominantly by the potentially restricted availability of the vault to the computer, and by the innocuous transfer of data to the computer, encryption of the password data inhibits non-computer based attack, such as by theft of the PMD itself.

Still more preferably, password data may be transferred between PMD devices without intervening use of the computer or storage thereon.

According to a broad aspect of an embodiment of the present invention, there is disclosed a password management device adapted for connection with a input port of a computer, the computer having a password accessible secure application associated therewith, the input port being associated with a user input device, the password management device comprising:

a password vault for storing password information; and

an output handler for providing data from the password vault to the application along the input port;

whereby the password management device may provide password information to the application in a manner indistinguishable to an operating system of the computer from direct user input at the input device.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a conventional computer configuration known in the art to which an inventive PMD according to the present invention could be introduced;

FIG. 2 is a block diagram of the configuration according to FIG. 1, with the inventive PMD according to a first embodiment of the present invention introduced therein;

FIG. 3 is a block diagram of an exemplary PMD according to the present invention;

FIG. 4 is a block diagram in which a PMD according to a second embodiment of the present invention is introduced to the prior art configuration of FIG. 1;

FIG. 5 is a block diagram in which the inventive PMD of FIG. 2 is introduced in a third embodiment;

FIG. 6 is a block diagram in which a PMD assembly according to a fourth embodiment of the present invention is introduced to the prior art configuration of FIG. 1;

FIG. 7 is a block diagram in which a PMD assembly according to a fifth embodiment of the present invention is integrated into a keyboard device;

FIG. 8 is a block diagram in which a PMD circuit is embedded within a keyboard in accordance with a sixth embodiment of the present invention is introduced to the prior art configuration of FIG. 1; and

FIG. 9 is a block diagram showing the exchange of password data between a pair of wireless-enabled PMDs according to a fifth embodiment of the present invention.

### DETAILED DESCRIPTION OF THE PREFERRED EMBODIMENTS

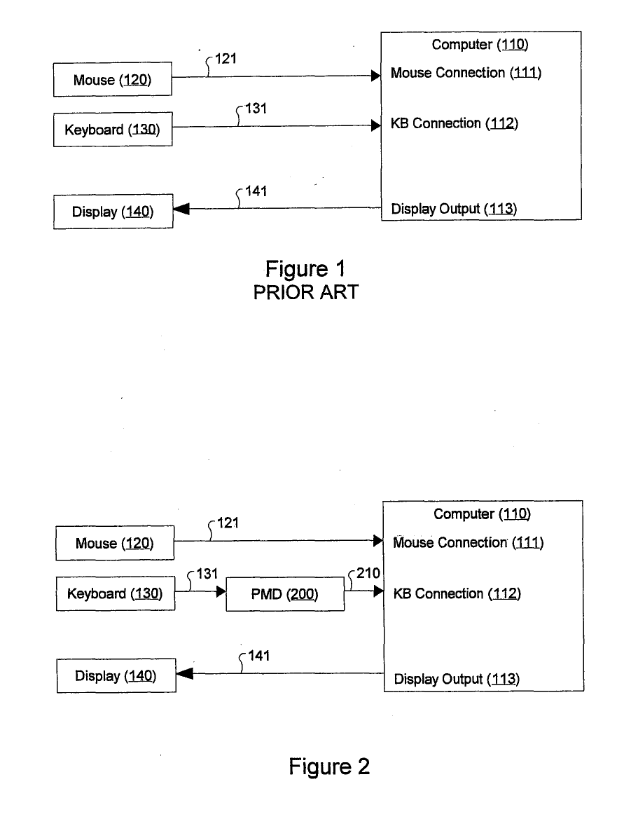

Referring now to FIG. 1, there is shown a block diagram of a conventional desktop computer system 100 known in the art to which an inventive PMD according to the present invention could be introduced. The system 100 comprises a computer 110, a mouse 120, a keyboard 130 and a display 140.

The computer 110 comprises memory, processing and communications components in conventional fashion (not shown) and certain I/O ports including a mouse connection 111, a keyboard connection 112 and an output display connection 113. The computer 110 is connected to and accepts input from the mouse 120 at its mouse connection 111, is connected to and accepts input from the keyboard 130 at its keyboard connection 112 and transmits output display signals to the display 140 at its output display connection 113.

The mouse 120 is a conventional mouse known in the art. Conventionally, it comprises a mouse cable 121 adapted for connection into the mouse connection 111.

The keyboard 130 is a conventional keyboard known in the art. Conventionally, it comprises a keyboard cable 131 adapted for connection into the keyboard connection 112.

The display 140 is a conventional output display device such as a computer monitor. Conventionally, it comprises a monitor cable 141 adapted for connection into the output display connection 113.

As is well known in the art, the keyboard 130 responds to user input thereon to generate a serial stream of key codes corresponding to the key sequence pressed, which travels along the keyboard cable 131 to the keyboard connection 112 of the computer 100. This stream of codes may, depending upon the application operating on the computer 100, comprise a password string assigned to permit user access to the security application.

Referring now to FIG. 2, there is shown a block diagram of the computer system 100 according to FIG. 1, with the introduction of a PMD 200 according to a first embodiment of the present invention.

The PMD 200 is connected between the keyboard cable 131 and the keyboard connection 112 and comprises a PMD cable 210 adapted for connection into the keyboard connection 112.

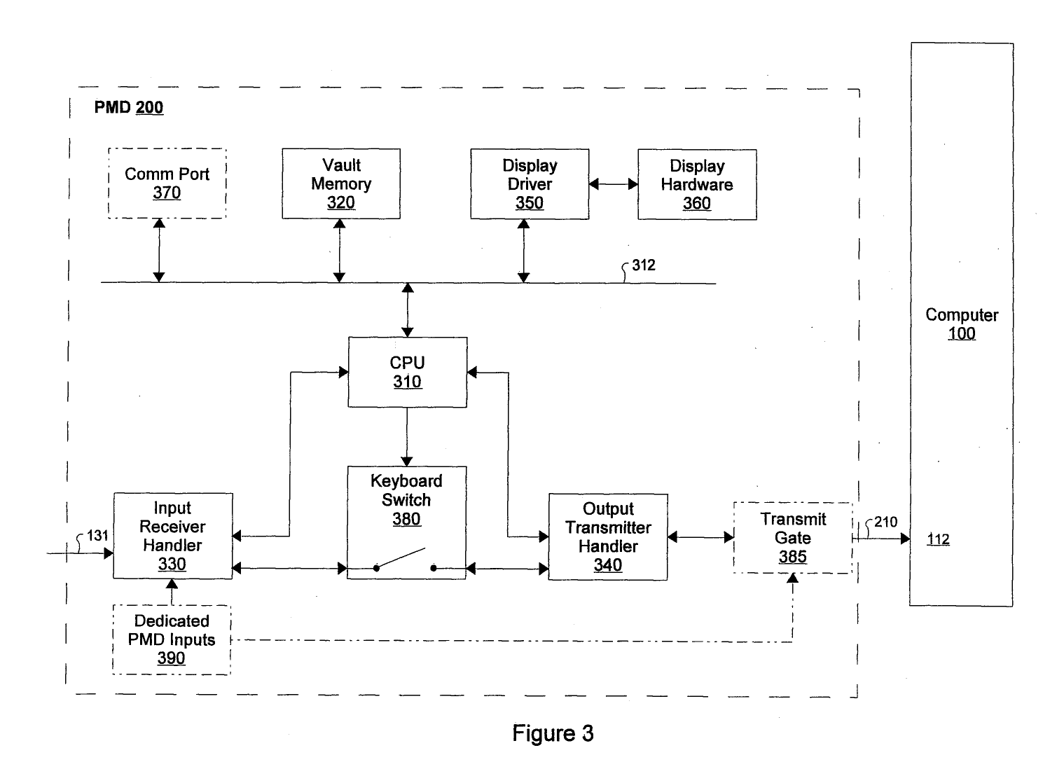

FIG. 3 shows a block diagram of the PMD 200. It comprises a CPU 310, a bus 312, a vault memory 320, an input receiver handler 330, an output transmitter handler 340, a keyboard switch 380, a display driver 350 and display hardware 360. Optionally it may comprise a transmit gate 385, a communications port 370 and a dedicated PMD input 390, all shown in dotted outline.

The CPU 310 comprises a microprocessor for management and control of the PMD 200. It is capable of communicating with other PMD components along bus 312. The CPU 310 interprets user inputs, manages data flow within the PMD 200, performs data processing and user interface management tasks and determines when and what data should be output to the host computer 100.

The vault memory 320 comprises non-volatile memory so that the password data will not be lost upon power interruption. The vault memory 320 stores the passwords in a vault database as well as ancillary data, such as configuration settings, authentication information and user identities.

The vault database is adapted to accept text passwords of varying length and formats and associate them with a user chosen internal identifier by which the password can be easily referenced by the user for subsequent use. Preferably, the vault memory 320 is adapted to handle passwords for a plurality of users. Optionally, the password comprises a plurality of components, such as a login and a password component. Other information may be associated with the password in the database in order to provide features that a user would typically expect with a password management solution, such as date of creation and date of expiry of the password data and/or the application or website with which the password data is associated.

Preferably the password data may be encrypted, either universally, or for specific passwords only. Those having ordinary skill in this art will readily recognize that it may be preferable not to encrypt all of the data stored in the vault 320, against the possibility that the encryption key is lost, forgotten or otherwise corrupted. In such a situation, leaving unencrypted sufficient data to identify the security applications for which passwords have been assigned would permit the user to contact the system administrators of the various applications to amend the passwords.

For data to be encrypted, a common encryption scheme may be employed across all data in the vault or different schemes may be applied to passwords corresponding to different users, different security applications etc. Those having ordinary skill in this art will readily recognize that for such purposes, the vault memory 320 and indeed the vault database may be divided either physically or architecturally in order to facilitate such features.

Optionally, the vault memory 320 may comprise removable non-volatile media, such as a memory card.

The input receiver handler 330 provides a means for entering data into, and interacting with, the PMD 200. In the first embodiment of the present invention, the keyboard 130 is utilized for this purpose. Keystrokes entered at the keyboard 130 are passed along the keyboard cable 131 to the input receiver handler 330. Those having ordinary skill in this art will recognize that the key codes entered may either be directly understood by the CPU 310, or can be translated into a form readable by the CPU 310. Those having ordinary skill in this art will recognize that there are a multitude of interface implementations for the keyboard 130, such as AT, PS/2, USB HID, or Bluetooth, and that in such circumstances the input receiver handler 330 may be consequently modified to support such implementations.

For some advanced security applications, password data may be input by other than keyboard input. For example, some hardware security applications may require the swiping of a smart card in a card reader. Others may require or permit data entry by a wireless connection such as Bluetooth or infrared transmitter or a specific interface such as a biometric reader (eg palm, fingerprint or retinal scan). Those having ordinary skill in this art will readily recognize that all such input devices will convert input responses into digital form. The PMD 200 may optionally incorporate such devices or interface between such input devices in like manner as the keyboard 130 within the scope of the present invention. One purpose of such an input could be to authenticate the user to the device, rather than requiring the user to remember a master access password.

Optionally, the input receiver handler 330 may be configured to accept inputs from a dedicated PMD input device (shown in dotted outline as 390) such as by a small keypad, buttons, scrollwheel or other data entry device located on the PMD 200 itself.

The output receiver handler 340 provides a means to enter data from or through the PMD 200 into the computer 100. The output receiver handler 340 is complementary to the input receiver handler 330 in that it generates output data in a format and sequence and across a connection that mimics that of the input device (such as the keyboard 130), so that it renders the PMD 200 indistinguishable from that of the input device it is supplanting or is interposed between.

The output transmitter handler 340 receives data and transmits it along PMD cable 210 to keyboard connection 112 in a manner appropriate for the keyboard connection in use (for example, as keyboard scan codes in the case of a PS/2 connection).

Still further, those having ordinary skill in this art will recognize that while typically used as an input connection, most computer keyboard connections are in fact bi-directional devices, so that the output transmitter handler 340 may in fact accept input from the computer 100 as well. However, such a configuration would typically involve the installation of software on the computer 100, the presence of which might compromise the innocuous nature of the PMD 200 since a typical keyboard does not require such additional software.

Alternatively, in order to permit PMD input from the computer 100 without the installation of such custom software processes, the PMD 200 may be configured to permit communications through alternative input ports adapted to accept conventional communications from the computer 100, such as via a standard device implementation like a USB mass storage endpoint. Such an implementation would use the standard drivers and applications that an operating system has to interact with the device. For example, the Windows Explorer application in the Microsoft Windows™ operating system can automatically interact with USB mass storage endpoints without the need for special software. Again, implementation of such additional communications facilities might jeopardize the innocuous nature of the PMD 200 communications with the computer 100.

The keyboard switch 380 permits the user to specify the state in which the PMD 200 operates. In an exemplary scenario, when the keyboard switch 380 is in a closed position, the PMD 200 is placed in a “keyboard pass-through” (KP) state, in which all key codes received at the input receiver handler 330 from the keyboard 130 are forwarded (or passed through) to the output transmitter handler 340 and out to the computer 100. While in the KP state, any key codes generated by the computer 100 intended for the keyboard 130, such as instructions to light an indicator thereon are received by the output transmitter handler 340 and forwarded (or passed through) to the input receiver handler 330 and out to the keyboard 130. Thus, the KP state would be appropriate for most keyboard inputs by the user, for example, when no password generation or submission is required. In the KP state, the PMD 200 is transparent, and it appears to the user that there is no PMD 200 present.

When the PMD 200 is to be used, for example to select a password to be transmitted, to generate/enter a new password, or utilize any other PMD 200 function, the keyboard switch 380 may be placed in an open position, so that the PMD 200 enters a “keyboard input” or “keyboard interrupted” (KI) state, in which key codes received at the input receiver handler 330 from the keyboard 130 are not passed on to the keyboard transmitter handler 340 or ultimately to the computer 100. Rather, such key codes are processed by the PMD 200 Once in the KI state the keyboard 130 can be used as the input for many PMD 200 features, such as entering in a master authentication password for the device (to differentiate between users or to preclude against the PMD 200 being activated by an unauthorized user if left unattended), navigating of PMD 200 menus, select a password to be transmitted to a security application on the computer 100, creating a password entry (with associated information) in the data vault, or to configure different PMD options.

In the course of such processing in the KI state, key codes may be selectively generated by the PMD 200 and forwarded on to the output transmitter handler 340 and out to the computer 100, for example, to transmit a desired password that was retrieved from the vault memory 320, or to communicate a password currently being defined to the secure application. In the latter case, upon being prompted by the security application to select a password, the user need simply select the appropriate PMD 200 mode and key in the desired password, confident that it would be accurately recorded for storage in the PMD 200.

Preferably, while in the KP state, key codes received by the input receiver handler 330 may also be accessed and processed by the PMD 200, for example, to watch for a pre-defined key sequence that will activate KI mode as a potential software implementation of the keyboard switch 380.

While in the KP state, keyboard inputs from the keyboard 130 are passed through the PMD 200 and transparently output to the keyboard connection 131 of the computer 100. When a password has been previously entered into the data vault as described above, the user, through keyboard inputs in the KP state, may have occasion to subsequently access the security application, and be prompted for entry of the password. In such a circumstance, the PMD 200 is placed, via the keyboard switch 380, into a KI state, in which data is accessed from the vault database and output along the output transmit handler 340 along the PMD cable 210 to the keyboard connection 131. In this fashion, the selected password can transparently (from the point of view of the security application and the computer 100), accurately and conveniently be submitted to the security application to gain access to the security application.

It will be recognized that as a more secure alternative to user-specification of passwords, the PMD 200 may be capable of configuration to auto-generate passwords when required. Such a capability may permit generation of random and more lengthy and/or complex password sequences, which may be correspondingly more resistant to discovery. The prevailing disincentives to such sequences has in the past been the difficulty in developing, remembering and consistently keying in such sequences, all of which will have been obviated by the automatic generation of such sequences, subsequent storage thereof, and automatic transmission by the PMD 200 itself.

Those having ordinary skill in this art will readily recognize that the specification of the selected password is communicated to the security application by the PMD 200 without the requirement for the installation of any PMD software on the computer 100.

In order to further spoof any hacker-introduced software monitors such as a keystroke logger on the computer 100, the output of the PMD 200 along the output transmitter handler 340 could be configured to be output in staggered or randomized timing so as to disguise the fact that an automated device is generating the keystrokes. Optionally, the CPU 310 could record the timing that the keystrokes were input by the user during the entry of the password and reproduce the timing with random variations in the KI state.

Just as the input receiver handler 330 could be replaced or supplemented by handlers corresponding to other input devices, such as biometric palm, fingerprint or retinal scan readers, the output transmitter handler 340 could similarly be replaced or supplemented by a handler consistent with such devices.

Those having ordinary skill in this art will readily recognize that the keyboard switch 380 need not necessarily constitute a physical switching device, but may be effected by software logic in the PMD 200 in response to a user input, such as a pre-determined and unique key code or sequence at the keyboard 130, or the usage of a dedicated PDM input 390 (such as a button).

Optionally, the PMD 200 may comprise a transmit gate (shown in dotted outline 385) whereby a user input is demanded prior to any data being output from the vault database to the computer 100. Implementing such a gating feature ensures that even if a hacker has compromised the security of the computer 100, it cannot read secure data from the PMD 200. Preferably, such a transmit gate 385 is a hardware switching device closed upon user input through a dedicated PMD input 390.

Optionally, the data gating feature may be implemented in software or firmware. However, this admits of the possibility of firmware update, which conceivably exposes the PMD 200 to security breach. In high security applications, hardware gating, such as a normally open momentary contact switch, would be appropriate.

Additionally, the transmission gate 385 may be configured to preclude the receipt of data from the computer 100. Effectively, such data gating features amount to disconnection of the PMD 200 from the computer 100 without physically moving the PMD 200.

The display driver 350 and the display hardware 360 provide to the user visual or other sensory feedback as to the state of the PMD as well as a mechanism to review the vault database contents. As is well known in the art, the display hardware 360 may comprise an LCD display, an array of LEDs or other output system, including auditory or tactile feedback. The display driver 350 will be configured to cooperate with the implemented display hardware 360.

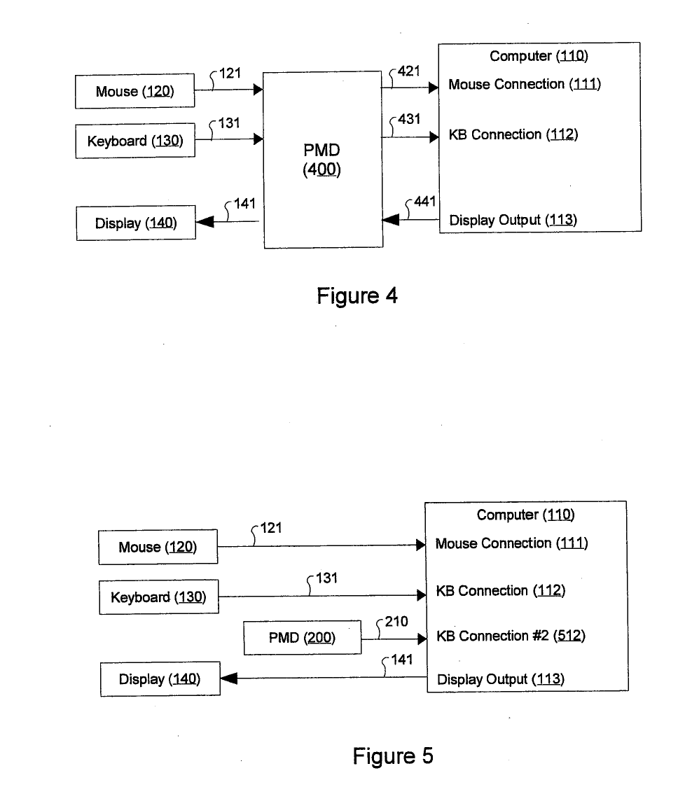

Turning to FIG. 4, there is shown a second embodiment in which the PMD 400 remains interposed between the keyboard 130 and the keyboard connection 112. However, in this alternative embodiment, the PMD 400 is also interposed between the mouse 120 (and the mouse cable 121) and the mouse connection 111 and between the display 140 (and the monitor cable 141) and the display output connection 113, with a PMD keyboard cable 410 interconnecting the PMD 400 and the keyboard connection 112, a PMD mouse cable 421 interconnecting the PMD 400 and the mouse connection and a PDM display cable 441 interconnecting the PMD 400 and the display output connection 113.

In such a configuration, the PMD 400 may utilize both the keyboard 130 and mouse 120 as inputs. Additionally, the PMD 400 may make use of the standard display 140. The display driver 350 could be modified so that when the PMD 400 needs to display a menu or other display, the image can be simply overlaid on the existing display 140. When no PMD 400 display is required, the video signal transmitted by the computer 100 is passed through to the display 140 without modification.

Referring now to FIG. 5, there is shown a block diagram in which the inventive PMD of FIG. 2 is introduced in an alternative third embodiment, namely connected to a second keyboard connection 512 rather than interposed between the keyboard cable 131 and the first keyboard connection 112. For example, independent of the interface type of the keyboard 130, the PMD 200 could connect as a USB HID device into any vacant USB port since the USB standard supports any number of connected HID devices, including multiple keyboards.

In such a configuration, the keyboard 130 could not be used as an input device to the PMD 200 and some dedicated PMD inputs may be appropriate. Moreover, those having ordinary skill in this art will readily appreciate that the keyboard 130 could be completely disconnected.

On the other hand, such a configuration would be suitable for use with a notebook or other computer configuration wherein the keyboard connection 112 and the keyboard cable 131 are integrated or where access to the keyboard connection 112 is not available, such as at an internet café site.

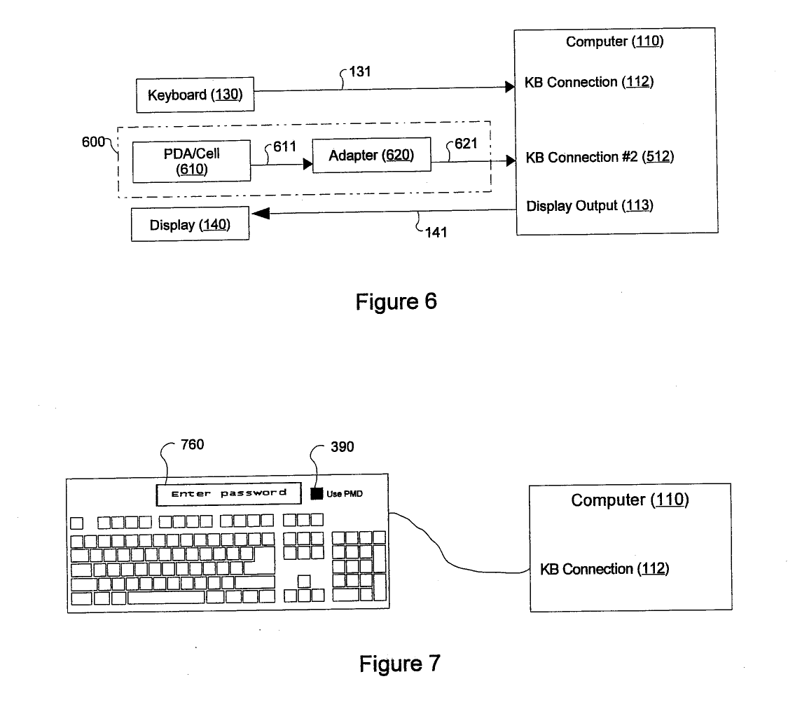

Turning to FIG. 6, there is shown a block diagram in which a PMD assembly 600 according to a fourth embodiment of the present invention is introduced to the prior art configuration of FIG. 1. In particular, the PMD assembly 600 comprises a conventional portable device 610 such as a cellular phone or a PDA and a PMD adapter 620. Like the third embodiment of FIG. 5, the PMD assembly 600 is not interposed between the keyboard 131 and the keyboard connection 112, but is connected to secondary keyboard connection 512.

The portable device 610 has resident thereon a PMD application that takes over the hardware resources of the portable device 610 for PMD purposes. For example, the on board memory of the portable device houses both application parameters and allocates a portion semi-permanently to the vault database. The PMD assembly 600 also makes use of the display capabilities of the portable device 610 in place of the display driver 350 and display hardware 360 and the data input capabilities of the portable device 610, whether keyboard, keypad or stylus-based, in place of the keyboard receiver handler 330 and optionally the keystroke interruption switch 380. Optionally, remote communications capability could dispense with an optional communications port.

The adapter 620 comprises the CPU 310, the keyboard transmitter handler 340 and optionally the transmit gate 385. The adapter 620 further comprises a hardware interface permitting communications between the PMD application on the portable device 610 and itself, for example, if the portable device is a PDA, along the PDA cradle data connection. Other communication features of the portable device, including but not limited to an infrared or Bluetooth port, wireless telephone or internet capability could similarly be appropriated to enable communications between the portable device 610 and the computer 100, via the adapter 620.

Typically, PDAs communicate with the computer 100 by means of a synchronization assembly, whether wired or wireless. Those having ordinary skill in this art will readily recognize that such synchronization introduces the possibility of security breach of the vault memory 320 through such assembly.

Those having ordinary skill in this art will readily recognize that there is no reason why the PMD 200 of the present invention could not be integrated with the keyboard 130 or other peripheral as shown in exemplary fashion in FIG. 7. In such a situation, the peripheral may comprise, in addition to its conventional features, a sensory indicator 760 to denote the status of the PMD features and minimal additional PMD input controls 390 to navigate about the PMD features and states. Those with ordinary skill in the art will recognize that, because the hardware is integrated within the keyboard case itself, there is no visible cable connection 131.

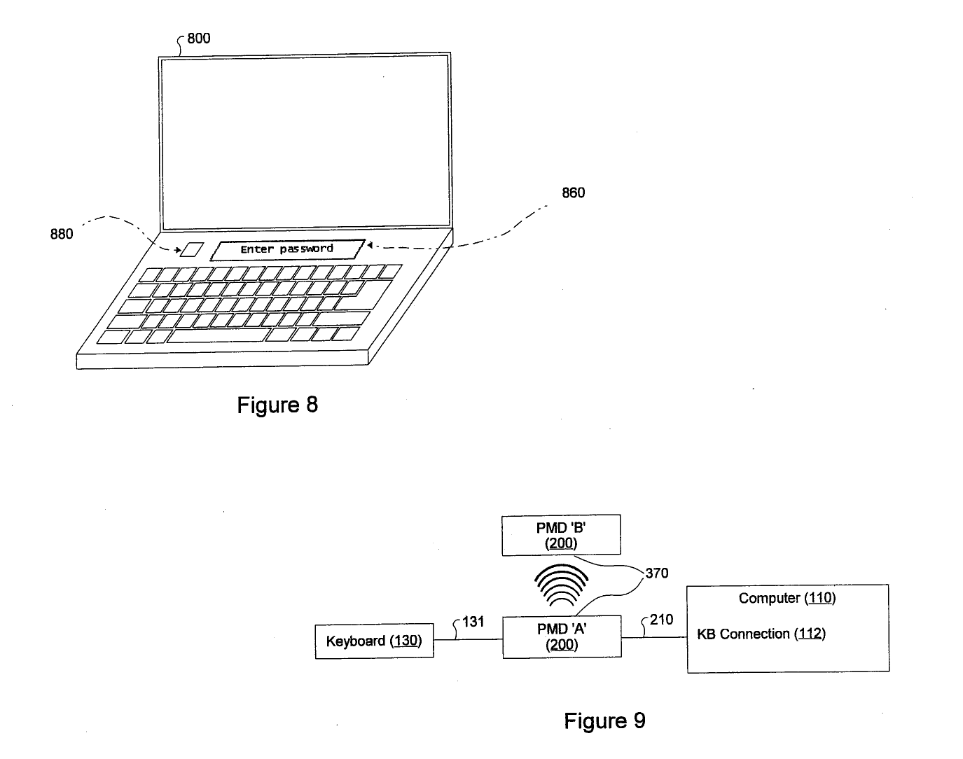

Similarly, the inventive PMD could conceivably be integrated with the computer 800 itself, whether in a desktop or laptop configuration as shown in FIG. 8. In such a configuration, all of the hardware for PMD functionality would be housed in the computer case itself. Any of the keyboard, mouse, and video display of the computer 800 could be utilized by the PMD. Preferably, all PMD hardware would be kept independent of the hardware in the computer 800. Additionally, sensory indicators 860 and inputs 880 could be implemented in a manner well known to those having ordinary skill in this art.

Either of the foregoing alternative embodiments would sacrifice one significant feature of the present invention, namely the portability and interoperability of the PMD 200 with multitudinous computer systems.

Such portability could be compensated for or enhanced by features including but not limited to removable memory chips and/or cards for insertion into complementary devices associated with other computers or to upgrade devices, wireless download/upload of vault data into complementary or upgraded PMDs 200, such as is shown in exemplary fashion in FIG. 9, using the optional communications port 370.

In addition, those having ordinary skill in this art will readily recognize that the functionality of the PMD 200 according to the present invention could be supplemented and/or enhanced by the implementation of certain administrative features including but not limited to diagnostics and data logging, management and storage of other useful and/or sensitive information, such as contact/calendar information, credit card information, health and/or financial records, or even document management. The PMD 200 could be conditioned to prompt for and demand the selection of a new password after a predetermined time interval or number of uses. Other administrative features could provide user specification or variation of parameters, such as for the makeup of generated passwords.

Further, the user inputs into the PMD 200 itself could be protected from potential attack by any of a plurality of security features known to those having ordinary skill in this art including limiting the number of unsuccessful attacks on the encrypted vault database contents.

The present invention can be implemented in digital electronic circuitry, or in computer hardware, firmware, software, or in combination thereof. Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in ASICs (application-specific integrated circuits) or FPGAs (field programmable gate arrays).

The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

I claim:

1. A password management device adapted for connection with a input port of a computer, the computer having a password accessible secure application associated therewith, the input port being associated with a user input device, the password management device comprising:
a password vault for storing password information; and
an output handler for providing data from the password vault to the application along the input port;
whereby the password management device may provide password information to the application in a manner indistinguishable to an operating system of the computer from direct user input at the input device.

2. A password management device according to claim 1, wherein the password management device may provide password information to the application in a manner indistinguishable to the application from direct user input at the input device.

3. A password management device according to claim 1, wherein the password management device may provide password information to the application in a manner indistinguishable to any software application on the computer from direct user input at the input device.

4. A password management device according to claim 1, wherein the data vault comprises non-volatile memory.

5. A password management device according to claim 2, wherein the data vault is removable therefrom.

6. A password management device according to claim 1, wherein data is stored within the data vault in encrypted form.

7. A password management device according to claim 1, wherein the password vault is adapted to store passwords of varying formats.

8. A password management device according to claim 1, wherein the password vault is adapted to store passwords associated with a plurality of users.

9. A password management device according to claim 1, wherein the input port is selected from a group comprising a keyboard input port, a serial communications port and a USB port.

10. A password management device according to claim 1, wherein the input device is a keyboard input device.

11. A password management device according to claim 1, wherein the input device is selected from a group comprising a biometric input device, a user pointing input device, a data reading input device and a wireless communications device.

12. A password management device according to claim 1, wherein the output handler emulates the input device.

13. A password management device according to claim 1, further comprising an input handler for accepting user input for storage in the password vault.

14. A password management device according to claim 13, wherein the input handler is adapted to forward user input to the output handler.

15. A password management device according to claim 13, wherein the input handler is adapted to accept user input from the input device.

16. A password management device according to claim 13, further comprising a PMD input device adapted to interface with the input handler.

17. A password management device according to claim 15, wherein the PMD input device is selected from a group comprising a keypad and a scrollwheel.

18. A password management device according to claim 13, further comprising gating means for selectively allowing the provision of data from the password vault to the output handler.

19. A password management device according to claim 18, wherein the gating means is user-selectable.

20. A password management device according to claim 1, further comprising an output driver for generating sensory outputs.

21. A password management device according to claim 20, wherein the output driver is adapted to generate outputs to an output peripheral associated with the computer.

22. A password management device according to claim 21, further comprising an output handler for accepting output commands from the computer and forwarding same to the output peripheral in a manner indistinguishable to the application and the computer from direct output from the computer to the output peripheral.

23. A password management device according to claim 20, further comprising an output device.

24. A password management device according to claim 23, wherein the output device is selected from a group comprising a display, a tactile output device and an aural output device.

25. A password management device according to claim 1, wherein the password management device comprises a portable communications device with an output port.

26. A password management device according to claim 25, wherein the portable communications device is selected from a group comprising a personal digital assistant and a cellular phone.

27. A password management device according to claim 25, further comprising an adapter for releasably connecting the output port to the input port.

28. A password management device according to claim 25, wherein the output port is a computer synchronization port.

29. A password management device according to claim 25, wherein the output port supports wireless communications.

30. A password management device according to claim 29, wherein the wireless communications port is adapted to create an internet connection.

31. A password management device according to claim 29, wherein the wireless communications port is adapted to create a telephone connection.

32. A password management device according to claim 29, wherein the wireless communications port is adapted to create an infrared communications link.

33. A password management device according to claim 29, wherein the wireless communications port is adapted to create a Bluetooth communications link.

34. A password management device according to claim 1, adapted to generate a password.

35. A password management device according to claim 1, wherein the password management device is integrated within the input device.

36. A password management device according to claim 1, wherein the password information is accessible only upon user authentication.

37. A password management device according to claim 1, wherein the password management device is integral with the computer.
